(19) United States
(12) Patent Application Publication
(10) Pub. No.: US 2020/0084508 A1
(43) Pub. Date: Mar. 12, 2020

(54) VIDEO PROCESSING APPARATUS

(71) Applicants: Kabushiki Kaisha Toshiba, Tokyo (JP); Toshiba Electronic Devices & Storage Corporation, Tokyo (JP)

(72) Inventor: Tsukasa Kudo, Kamakura Kanagawa (JP)

(21) Appl. No.: 16/562,648

(22) Filed: Sep. 6, 2019

(30) Foreign Application Priority Data
Sep. 7, 2018 (JP) 2018-168153

(51) Int. Cl. H04N 21/44; H04N 21/4335; H04N 5/04

(52) U.S. Cl. CPC H04N 21/44004; H04N 5/04; H04N 21/4335

(57) ABSTRACT

A video processing apparatus includes: an input section configured to receive an input signal as an input; a first FIFO configured to store input pixel data included in the input signal; a video processing section configured to generate output pixel data by performing predetermined video processing on the input pixel data; a second FIFO configured to store the output pixel data; a timer configured to measure a delay time starting from a time point at which a beginning location of the input pixel data is detected until a stored amount in the second FIFO becomes equal to or more than a predetermined threshold value; and a synchronization signal output section configured to output output synchronization signals used for outputting an output signal that is delayed by the delay time from the input signal.

### CROSS REFERENCE TO RELATED APPLICATION

This application is based upon and claims the benefit of priority from the prior Japanese Patent Application No. 2018-168153 filed in Japan on Sep. 7, 2018; the entire contents of which are incorporated herein by reference.

### FIELD

An embodiment described herein relates generally to a video processing apparatus.

### BACKGROUND

Conventionally, video processing apparatuses have been used to perform video processing such as scaling on an input signal and output an output signal in real time. After the input signal is inputted, the video processing apparatuses delay a timing of outputting the output signal, depending on a delay amount required for the video processing.

In the video processing apparatuses, particularly when a difference in crude density is generated between the input signal and the output signal due to scaling or the like, images subjected to the video processing may become insufficient in an output buffer if a delay time for the timing of outputting the output signal is too short, with a result that an underflow may occur in an internal video data path. If the delay time is too long, images subjected to the video processing may pour out of the output buffer, with a result that an overflow may occur in the video data path. When an underflow or an overflow occurs, the video processing apparatuses cannot correctly output the output signal in some cases.

### BRIEF DESCRIPTION OF THE DRAWINGS

FIG. 1 is a block diagram showing an example of a configuration of a video processing apparatus according to an embodiment.

FIG. 2 is an explanatory diagram for explaining an example of processing of measuring a delay time in the video processing apparatus according to the embodiment.

FIG. 3 is an explanatory diagram for explaining an example of signal output processing in the video processing apparatus according to the embodiment.

FIG. 4 is a waveform diagram showing an example of waveforms of an input signal and an output signal of the video processing apparatus according to the embodiment.

### DETAILED DESCRIPTION

A video processing apparatus according to an embodiment includes an input section, a first FIFO, a video processing section, a second FIFO, a timer, and a synchronization signal output section. The input section is configured to receive an input signal as an input. The first FIFO is configured to store input pixel data included in the input signal. The video processing section is configured to generate output pixel data by performing predetermined video processing on the input pixel data. The second FIFO is configured to store the output pixel data. The timer is configured to measure a delay time starting from a time point at which a beginning location of the input pixel data is detected until a stored amount in the second FIFO becomes equal to or more than a predetermined threshold value. The synchronization signal output section is configured to output output synchronization signals used for outputting an output signal that is delayed by the delay time from the input signal.

### EMBODIMENT

Hereinafter, the embodiment will be described with reference to drawings.

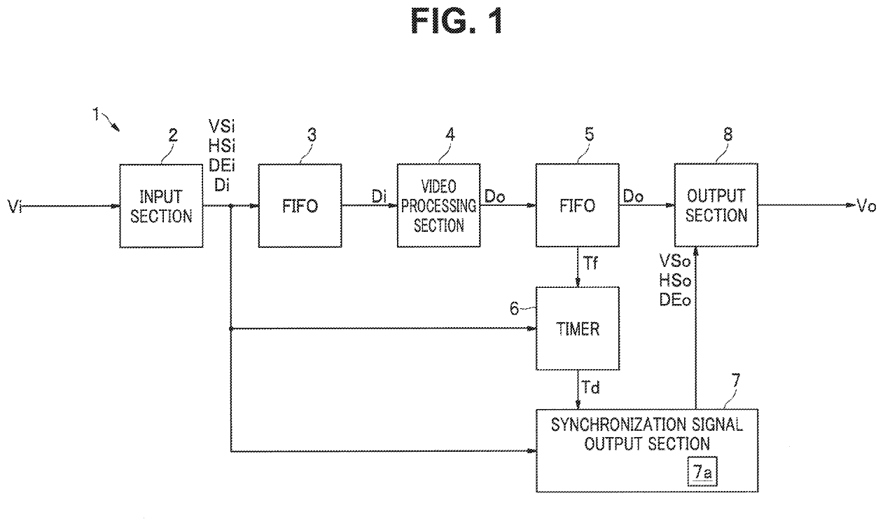

FIG. 1 is a block diagram showing an example of a configuration of the predetermined video processing apparatus.

As shown in FIG. 1, a video processing apparatus 1 performs the predetermined video processing on an inputted input signal Vi and outputs an output signal Vo. The video processing apparatus 1 includes an input section 2, a FIFO 3, which is the first FIFO, a video processing section 4, a FIFO 5, which is the second FIFO, a timer 6, a synchronization signal output section 7, and an output section 8.

Each of the input signal Vi and the output signal Vo may be, for example, a signal based on any of HDMI (registered trademark), DVI (registered trademark), Display Port (registered trademark), and MIPI (registered trademark) technologies, or may be a signal based on another video technology.

The input section 2 is a circuit configured to acquire an input vertical synchronization signal VSi, an input horizontal synchronization signal HSi, an input data enable signal DEi, and input pixel data Di from the input signal Vi, and to output the input vertical synchronization signal VSi, the input horizontal synchronization signal HSi, the input data enable signal DEi, and the input pixel data Di to the FIFO 3, the timer 6, and the synchronization signal output section 7. The input vertical synchronization signal VSi, the input horizontal synchronization signal HSi, and the input data enable signal DEi are input synchronization signals.

The FIFO 3 is a buffer configured to temporarily store the input pixel data Di inputted from the input section 2 in a first-in first-out manner. From the FIFO 3, the input pixel data Di stored earlier is sequentially read by the video processing section 4. To make a space in a storage area, the FIFO 3 deletes the input pixel data Di that has been read by the video processing section 4.

The video processing section 4 is configured to generate the output pixel data Do by performing the predetermined video processing on the input pixel data Di. More specifically, the video processing section 4 reads the input pixel data Di from the FIFO 3 in accordance with a predetermined operation clock, performs the predetermined video processing on internal images based on the input pixel data Di, and outputs to the FIFO 5 the output pixel data Do based on the internal images subjected to the predetermined video processing.

The predetermined operation clock is determined so as to cause the video processing section 4 to operate faster than a speed at which the input pixel data Di is stored in the FIFO 3 and also faster than a speed at which the output pixel data Do is read from the FIFO 5.

The predetermined video processing is, for example, magnification processing or reduction processing such as bilinear interpolation or bicubic interpolation. The predetermined video processing is not limited to the magnification processing or the reduction processing, but may be other video processing.

The FIFO 5 is a buffer configured to temporarily store the output pixel data Do inputted from the video processing section 4 in a first-in first-out manner. From the FIFO 5, the output pixel data Do stored earlier is sequentially read by the output section 8. To make a space in a storage area, the FIFO 5 deletes the output pixel data Do that has been read by the output section 8.

The FIFO 5 is also configured to output a control signal Tf to the timer 6 when a stored amount of the output pixel data Do becomes equal to or more than the predetermined threshold value during processing of measuring the delay time Td. The predetermined threshold value is determined at, for example, a maximum value of the stored amount.

The timer 6 is a circuit configured to measure the delay time Td starting from the time point at which the beginning location of the input pixel data Di is detected until the stored amount in the FIFO 5 becomes equal to or more than the predetermined threshold value, and to output the delay time Td to the synchronization signal output section 7. In other words, the timer 6 measures the delay time Td starting when the stored amount in the FIFO 5 is 0 until the stored amount in the FIFO 5 becomes the maximum value, and outputs the delay time Td to the synchronization signal output section 7.

For example, the timer 6 includes a counter. When the timer 6 detects a first valid period in the input data enable signal DEi inputted from the input section 2, the timer 6 starts driving the counter. The valid period is a time period during which the input pixel data Di is set in the input signal Vi. When the control signal Tf is inputted from the FIFO 5, the timer 6 stops driving the counter, calculates the delay time Td based on a count value of the counter and a time period per count, and outputs the calculated delay time Td to the synchronization signal output section 7.

The synchronization signal output section 7 is a circuit configured to output to the output section 8 the output synchronization signals used for outputting the output signal Vo that is delayed by the delay time Td from the input signal Vi. The synchronization signal output section 7 includes a register 7a configured to store the delay time Td obtained through the processing of measuring the delay time Td and inputted from the timer 6. The output synchronization signals include an output vertical synchronization signal VSo, an output horizontal synchronization signal HSo, and an output data enable signal DEo delayed by the delay time Td from the input signal Vi.

The synchronization signal output section 7 outputs the output synchronization signals in such a manner that a beginning valid period for the output pixel data Do starts after a delay of the delay time Td from the time point at which the beginning location of the input pixel data Di is detected. The synchronization signal output section 7 detects the beginning location based on the input data enable signal DEi included in the input signal Vi and outputs the output synchronization signals including the output data enable signal DEo in which valid periods delayed by the delay time Td are provided.

The output vertical synchronization signal VSo is a synchronization signal in a vertical direction and indicates an output cycle of one frame of the output pixel data Do. A length of the output vertical synchronization signal VSo for one cycle is determined depending on a frame rate of the output signal Vo. For example, if the input signal Vi and the output signal Vo have the same frame rate, a length of the output signal Vo for one cycle is the same as a length of the input signal Vi for one cycle.

The output horizontal synchronization signal HSo is a synchronization signal in a horizontal direction and indicates an output cycle of the output pixel data Do in the horizontal direction. A length of the output horizontal synchronization signal HSo for one cycle is determined depending on the length of the output vertical synchronization signal VSo for one cycle and the number of vertical lines. As the number of vertical lines increases, the length of the output horizontal synchronization signal HSo for one cycle becomes shorter.

The output data enable signal DEo indicates a valid period during which one horizontal line of the output pixel data Do is valid. The same number of valid periods as the number of vertical lines are provided, depending on the cycle indicated by the output horizontal synchronization signal HSo.

The synchronization signal output section 7 reads the delay time Td from the register 7a and determines a start time of the output data enable signal DEo that is delayed by the delay time Td. The synchronization signal output section 7 also determines a start time of the output vertical synchronization signal VSo, depending on the output data enable signal DEo. The start time of the output vertical synchronization signal VSo is, for example, a time of day a predetermined time period earlier than the start time of the output data enable signal DEo. The synchronization signal output section 7 also determines a start time of the output horizontal synchronization signal HSo, depending on the start time of the output vertical synchronization signal VSo.

The synchronization signal output section 7 generates the output vertical synchronization signal VSo, the output horizontal synchronization signal HSo, and the output data enable signal DEo, which are predetermined depending on the output pixel data Do, starting from the respective start times, and outputs the output vertical synchronization signal VSo, the output horizontal synchronization signal HSo, and the output data enable signal DEo to the output section 8.

The synchronization signal output section 7 is also configured to output an instruction signal, which instructs the output section 8 to mute video output, during the processing of measuring the delay time Td.

The output section 8 is a circuit configured to set the output pixel data Do in time periods indicated by the output synchronization signals and to output the output signal Vo to an outside. More specifically, the output section 8 reads the output pixel data Do from the FIFO 5. Subsequently, the output section 8 generates the output signal Vo by setting the output pixel data Do in the valid periods indicated by the output data enable signal DEo inputted from the synchronization signal output section 7, and outputs the output signal Vo to an outside. One horizontal line of the output pixel data Do is set in one valid period sequentially.

When the instruction signal instructing to mute video output is inputted from the synchronization signal output section 7, the output section 8 mutes video output by the output signal Vo. For example, the muting of video output may be performed by using the output signal Vo that makes a screen undisplayed, or may be performed by using the output signal Vo that turns the screen in a predetermined color. Alternatively, the output signal Vo may include a message notifying on-mute. That is to say, during the processing of measuring the delay time Td, the synchronization signal output section 7 outputs the instruction signal instructing to mute video output, and the output section 8, in response to the instruction signal, outputs the output signal Vo with video output muted.

### (Operation)

Next, the processing of measuring the delay time Td in the video processing apparatus 1 will be described.

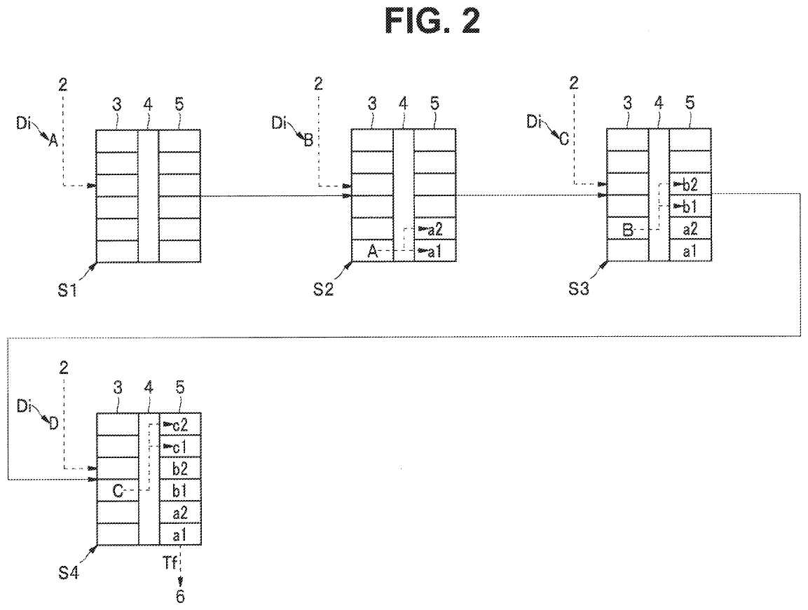

FIG. 2 is an explanatory diagram for explaining an example of the processing of measuring the delay time Td in the video processing apparatus 1. In FIG. 2, each of input pixel data A, B, C, and D and each of output pixel data a1, a2, b1, b2, c1, and c2 represents one horizontal line of data.

In the embodiment, an example will be described in which the video processing section 4 performs magnification processing on one horizontal line of the input pixel data Di so as to double a resolution in the vertical direction, and outputs two horizontal lines of the output pixel data Do.

The video processing apparatus 1 performs the processing of measuring the delay time Td at a beginning frame of the input signal Vi.

When the input signal Vi is inputted, the input section 2 acquires the input vertical synchronization signal VSi, the input horizontal synchronization signal HSi, the input data enable signal DEi, and the input pixel data Di from the input signal Vi, and outputs the input vertical synchronization signal VSi, the input horizontal synchronization signal HSi, the input data enable signal DEi, and the input pixel data Di to the FIFO 3, the timer 6, and the synchronization signal output section 7.

When the synchronization signal output section 7 detects the input vertical synchronization signal VSi for a first time, the synchronization signal output section 7 instructs the output section 8 to mute video output by outputting the instruction signal. When the instruction signal is inputted, the output section 8 starts muting video output.

When the timer 6 detects the input vertical synchronization signal VSi, the timer 6 clears the counter. When the timer 6 detects a first valid period from the input data enable signal DEi, the timer 6 starts driving the counter.

As shown at S1, the FIFO 3 and the FIFO 5 are empty.

As shown at S2, the FIFO 3 stores the input pixel data A inputted from the input section 2. The video processing section 4 reads the input pixel data A, generates the output pixel data a1 and a2, and outputs the output pixel data a1 and a2 to the FIFO 5. The FIFO 3 deletes the input pixel data A read by the video processing section 4. The FIFO 5 stores the output pixel data a1 and a2.

As shown at S3, the FIFO 3 stores the input pixel data B. The video processing section 4 reads the input pixel data B, generates the output pixel data b1 and b2, and outputs the output pixel data b1 and b2 to the FIFO 5.

As shown at S4, the FIFO 3 stores the input pixel data C. The video processing section 4 reads the input pixel data C, generates the output pixel data c and c2, and outputs the output pixel data c1 and c2 to the FIFO 5.

When the stored amount in the FIFO 5 reaches the maximum value, the FIFO 5 outputs the control signal Tf to the timer 6.

The timer 6 stops driving the counter, calculates the delay time Td, and outputs the calculated delay time Td to the synchronization signal output section 7.

When the delay time Td is outputted, the FIFO 5 deletes the output pixel data a1, a2, b1, b2, c1, and c2.

When the delay time Td is inputted, the synchronization signal output section 7 stores the delay time Td in the register 7a. The processing of measuring the delay time Td is terminated.

Next, signal output processing in the video processing apparatus 1 will be described.

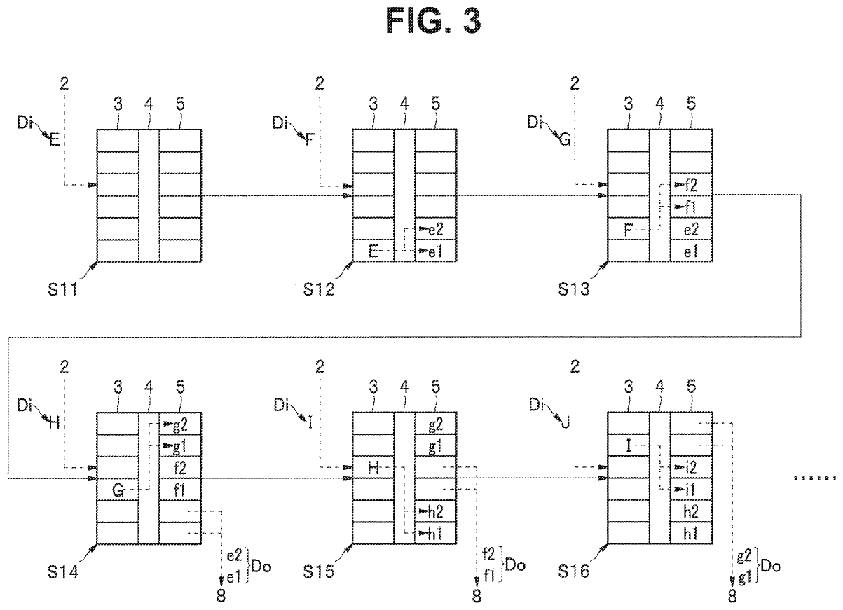

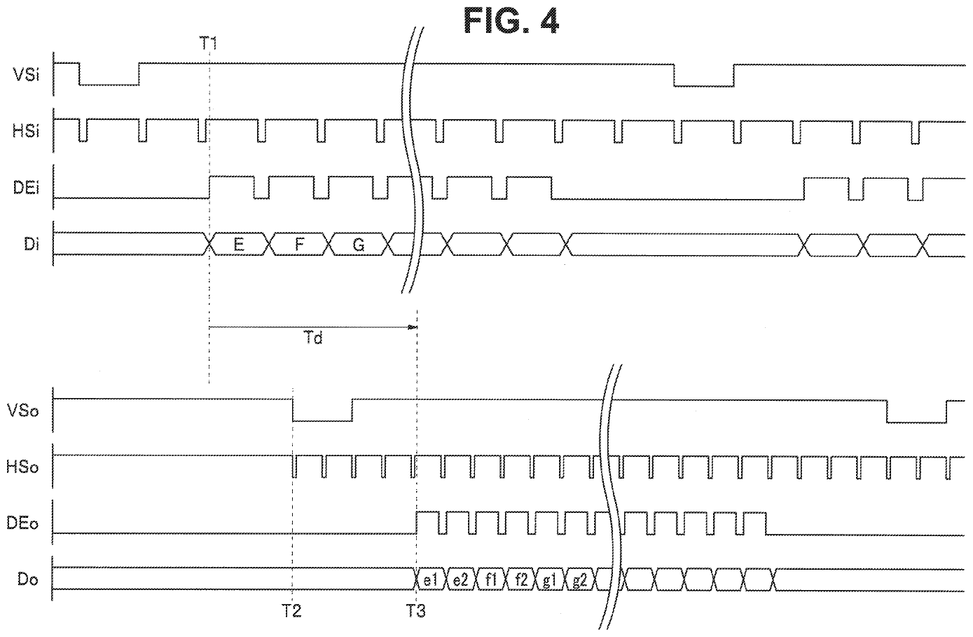

FIG. 3 is an explanatory diagram for explaining an example of the signal output processing in the video processing apparatus 1. FIG. 4 is a waveform diagram showing an example of waveforms of the input signal Vi and the output signal Vo of the video processing apparatus 1. In FIG. 3, each of input pixel data E, F, G, H, I, and J represents the input pixel data Di, and each of output pixel data e1, e2, f1, f2, g1, g2, h1, h2, i1, and i2 represents the output pixel data Do.

The video processing apparatus 1 performs the signal output processing, for example, from a second frame of the input signal Vi.

When the input signal Vi is inputted, the input section 2 outputs the input vertical synchronization signal VSi, the input horizontal synchronization signal HSi, the input data enable signal DEi, and the input pixel data Di to the FIFO 3 and the synchronization signal output section 7.

When the synchronization signal output section 7 detects the input vertical synchronization signal VSi, the synchronization signal output section 7 instructs to cease from muting video output by outputting an instruction signal. When the instruction signal is inputted, the output section 8 ceases from muting video output.

As shown at S11 in FIG. 3, the FIFO 3 and the FIFO 5 are empty.

At a time T1 in FIG. 4, when the synchronization signal output section 7 detects a first valid period in the input data enable signal DEi, the synchronization signal output section 7 reads the delay time Td from the register 7a and determines a start time T3 of the output data enable signal DEo depending on the delay time Td. The synchronization signal output section 7 also determines a start time T2 of the vertical synchronization signal depending on the start time of the output data enable signal DEo. The synchronization signal output section 7 also determines a start time of the output horizontal synchronization signal HSo depending on the start time T2 of the vertical synchronization signal.

As shown at S12 to S14, the FIFO 3 stores the input pixel data E, F, and G inputted from the input section 2. The video processing section 4 reads the input pixel data E, F, and G, generates the output pixel data e1, e2, f1, f2, g1, and g2, and outputs the output pixel data e1, e2, f1, f2, g1, and g2 to the FIFO 5.

At the time T2 during S12 to S14, the synchronization signal output section 7 starts outputting the output vertical synchronization signal VSo and the output horizontal synchronization signal HSo.

At the time T3, the synchronization signal output section 7 starts outputting the output data enable signal DEo.

The length of the output vertical synchronization signal VSo for one cycle is the same as a length of the input vertical synchronization signal VSi for one cycle. The length of the output horizontal synchronization signal HSo for one cycle is half of a length of the input horizontal synchronization signal HSi for one cycle. The number of valid periods in one frame of the output data enable signal DEo is twice the number of valid periods in one frame of the input data enable signal DEi.

The output section 8 reads the output pixel data e1 and e2 from the FIFO 5 and outputs the output signal Vo in which the output pixel data e1 and e2 are set in the valid periods indicated by the output data enable signal DEo. The FIFO 5 deletes the output pixel data e1 and e2.

As shown at S15 and S16, the FIFO 3 stores the input pixel data H and I. The video processing section 4 reads the input pixel data H and I and outputs the output pixel data h1, h2, i1, and i2 to the FIFO 5. From the FIFO 5, the output pixel data f1, f2, g1, and g2 are read by the output section 8. The FIFO 5 deletes the read output pixel data f1, f2, g1, and g2 and stores the output pixel data h1, h2, i1, and i2.

Thus, in the video processing apparatus 1, a delay of the delay time Td is made after the input signal Vi is inputted, a stored amount in the FIFO 5 falls in a state close to the maximum value and a stored amount in the FIFO 3 falls in a state close to 0, and then output of the output signal Vo is started. Even if an amount of the output pixel data Do outputted from the video processing section 4 temporarily decreases, the stored amount in the FIFO 5 is close to the maximum value, and an underflow is therefore suppressed. Even if an amount of the input pixel data Di inputted into the input section 2 temporarily increases, the stored amount in the FIFO 3 is close to 0, and an overflow is therefore suppressed.

According to the embodiment, the video processing apparatus 1 can output the output signal Vo that is delayed from the input signal Vi by the more optimally set delay time Td, and thus an underflow and an overflow of the video data path can be suppressed.

Note that when the predetermined video processing is performed so as to make the resolution in the vertical direction n times higher, the synchronization signal output section 7 may increase the number of valid periods n times by shortening each valid period in the output data enable signal DEo compared to each valid period in the input data enable signal DEi. Note that if a resolution in the horizontal direction is increased or decreased, the number of valid periods in the output data enable signal DEo is not changed from the number of valid periods in the input data enable signal DEi.

Note that although an example in which the video processing section 4 reads one line at a time is described in the embodiment, the video processing section 4 may read a plurality of lines at a time from the FIFO and perform the predetermined video processing.

Note that although an example in which the processing of measuring the delay time Td is performed at the beginning frame and the output signal Vo is outputted from the second frame onward based on the measured delay time Td is described in the embodiment, the present invention is not limited to such an example. For example, the processing of measuring the delay time Td may be performed in a development process or a manufacturing process and the delay time Td may be stored in the register 7a. In such a case, the signal output processing may be performed from the beginning frame based on the delay time Td stored in the register 7a. The processing of measuring the delay time Td may be performed at an arbitrary timing in response to an instruction from a user, or may be performed at a predetermined timing.

Note that although an example in which each of the FIFO 3 and the FIFO 5 has six storage areas is described in the embodiment, the number of storage areas is not limited to six.

Note that the configuration of each section and each circuit in the embodiment may be implemented by using hardware or may be implemented by using a program executed by a processor. For example, the synchronization signal output section 7 may be configured with a control register, and the register 7a may be configured with a status register. In such a case, the delay time Td may be stored in the status register, and the control register may be configured to read the delay time Td from the status register. The control register may also be configured to output instruction signals to the output section 8 to mute video output and to cease from muting video output.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A video processing apparatus, comprising:
an input section configured to receive an input signal as an input;
a first FIFO configured to store input pixel data included in the input signal;
a video processing section configured to generate output pixel data by performing predetermined video processing on the input pixel data;
a second FIFO configured to store the output pixel data;
a timer configured to measure a delay time starting from a time point at which a beginning location of the input pixel data is detected until a stored amount in the second FIFO becomes equal to or more than a predetermined threshold value; and
a synchronization signal output section configured to output output synchronization signals used for outputting an output signal that is delayed by the delay time from the input signal.

2. The video processing apparatus according to claim 1, wherein the synchronization signal output section outputs the output synchronization signals in such a manner that a beginning valid period for the output pixel data starts after a delay of the delay time from the time point at which the beginning location is detected.

3. The video processing apparatus according to claim 1, wherein the synchronization signal output section includes a register, and
the register is configured to store the delay time.

4. The video processing apparatus according to claim 1, wherein the synchronization signal output section detects the beginning location based on an input data enable signal included in the input signal and outputs the output synchronization signals including an output data enable signal in which valid periods delayed by the delay time are provided.

5. The video processing apparatus according to claim 1, wherein the timer measures the delay time that allows the stored amount in the second FIFO to become a maximum value.

6. The video processing apparatus according to claim 1, further comprising an output section, wherein
the output section is configured to set the output pixel data in periods indicated by the output synchronization signals and to output the output signal to an outside.

7. The video processing apparatus according to claim 6, wherein the synchronization signal output section outputs an instruction signal instructing to mute video output during processing of measuring the delay time, and
the output section outputs the output signal with video output muted in response to the instruction signal.

8. The video processing apparatus according to claim 1, wherein the synchronization signal output section is configured with a control register,
the delay time is stored in a status register, and
the control register reads the delay time from the status register.
